(19) United States
(12) Patent Application Publication
(10) Pub. No.: US 2012/0269586 A1
(43) Pub. Date: Oct. 25, 2012

(54) DEVICE FOR FEEDING A FLUID INTO A SOLID-CONVEYING LINE

(75) Inventors: Stefan Hamel, Wenden (DE); Stefan Hacker, Bochum (DE)

(73) Assignee: ThyssenKrupp Uhde GmbH, Dortmund (DE)

(21) Appl. No.: 13/514,680

(22) PCT Filed: Nov. 9, 2010
(86) PCT No.: PCT/EP2010/006808

§ 371 Date: Jun. 8, 2012

(30) Foreign Application Priority Data
Dec. 9, 2009 (DE) 10 2009 057 380.1

(51) Int. Cl. B65G 53/40

(52) U.S. Cl. 406/108

(57) ABSTRACT

With a device for feeding a fluid, such as a gas or a liquid, into a solid-conveying line, wherein the fluid is first passed into a ring space that surrounds the solid-conveying line, and from there into the solid-conveying line, conveying of coal in the form of dust or flue ash, for example, is to be undertaken in gasification systems, at elevated temperatures, at great output and great operational reliability. This is achieved in that the solid-conveying line is shorter, in the ring space for forming a ring gap, than the length of the ring space, wherein installations for producing a vortex flow of the fluid that is introduced are provided in the ring space.

The invention is directed at a device for feeding a fluid, such as a gas or a liquid, into a solid-conveying line, whereby the fluid is first passed into a ring space that surrounds the solid-conveying line, and from there into the solid-conveying line.

The invention proceeds, for example, from EP 1 824 766 31, in which the solid-conveying line is formed within a housing made of a permeable material, which housing forms the ring space, and is disposed so as to be longitudinally displaceable, by way of ring seals on both sides. Pneumatic conveying is known for transporting particulate solids. Depending on the flow regime and conveying density, a rough distinction is made between thin-stream and dense-stream conveying. In this connection, U.S. Pat. No. 3,152,839, U.S. Pat. No. 1,152,302 or DD 0 154 599 are part of the prior art.

Dense-stream conveying is characterized by a comparatively low use of conveying gas and a method of operation that is gentle on both the solid and on the conveying line, and is used in a broad spectrum of applications, such as, for example, for conveying coal dust, flue ash, cement, but also in the foods industry and pharmaceutical industry, whereby the process-technology parameters for conducting pneumatic conveying in a dense stream as well as in a thin stream have been known for a long time, and, with increasing demands on technical systems, such as system availability, useful lifetimes, investment costs, ease of maintenance, etc., new solutions are being required to satisfy these constantly increasing demands.

Aside from EP 1 824 766 B1, which has already been mentioned, there are also other solutions that describe the feed of gases for conveying solids, for example, in order to fluidize the solid at the beginning of or even during conveying, in order to influence the conveying density or to flush pipe segments:

This prior art also includes, for example, WO 2004/87331 A1, in which a system for conveying powdered material, particularly paint powders, to a spray application device is described. In this device, a double-walled pipe element is used, which also is provided with a permeable inner wall, consisting of sintered metal, for introducing air into the powder. The double-walled element described in WO 2004/87331 A1 does not provide for any expansion accommodations, but rather is completely screwed together, according to the specification and the drawings, using compressed air hose technology. Therefore use in the area of operation planned here (high temperatures and high pressures) is not possible here, and not transferable.

A double-walled pipe is also presented in DE 1 269 571. The inner pipe wall is made of porous material, whereby the particular feature consists in that the material is expandable and flexible. The pressure impacts that are applied bring about a movement of the inner wall, by means of which part of the air simultaneously gets into the solid stream, because of the porosity. The porosity described, with simultaneous flexibility, can be fulfilled at the same time only by materials such as plastics. As a result, use of the suggestion of DE 1 269 571 in the present case, at solid temperatures up to 400° C., cannot be used.

Other solutions for air conveying or conveying with a fluid that stands under pressure are described by U.S. Pat. No. 5,827,370 A or U.S. Pat. No. 6,227,768 B.

It is the task of the invention to undertake a device for conveying coal in the form of dust or flue ash in gasification systems, at elevated temperatures, at great output and great operational reliability.

In the case of a device of the type indicated initially, this task is accomplished, according to the invention, in that the solid-conveying line, referred to hereinafter as an inner guide pipe, is shorter, in the ring space for forming a ring gap, than the length of the ring space, whereby installations for producing a vortex flow of the fluid that is introduced are provided in the ring space.

With the invention, it becomes possible, because the gas that is generally supplied in such cases has a lower temperature and up to, in part, significant temperature differences between the solid-conducting and the gas-conducting side, with the resulting different expansions of the components, to make available a compensation in the expansion differences, in order to prevent damage to corresponding elements in the long term.

With the invention, another problem is also solved, which results from the fact that generally, solid-conveying components are cyclically impacted because of pressures that prevail in gasification systems, of up to 100 bar. Vice versa, solids that are released in the process, such as flue ash, must be transferred out, whereby high pressure is transferred out to atmospheric pressure from the system. This also happens in transfer systems that work cyclically, i.e. temporal temperature gradients that result from the cyclical method of operation are added to the temperature differences on the basis of the different media temperatures. These problems are taken into account by means of the special design of the device according to the invention.

Embodiments of the invention are evident from the dependent claims. In this connection, it can be provided that the region of the inner guide pipe in the ring space is configured to be at least partially perforated. With this design, feed of the conveying gas into regions of the solid-conveying line is guaranteed in the same manner as by the ring gap at the end of the inner guide pipe in the ring space.

In order to facilitate blowing out solids that have trickled back in, if necessary, in the case of cyclical operation, the ring space is equipped with a funnel-shaped wall region in the region of the ring gap to the solid-conveying line.

It is practical if all the elements are attached to one another by way of flange connections, in known manner.

If the position of the device deviates from an orientation in the direction of gravity, then it can also be provided, according to the invention, that the feed line to the ring space for the fluid is positioned in the upper region of the ring space, in the direction of gravity, if the solid-conveying line is not positioned in the direction of gravity.

Further characteristics, details, and advantages of the invention are evident from the following description and from the drawing; this shows, in:

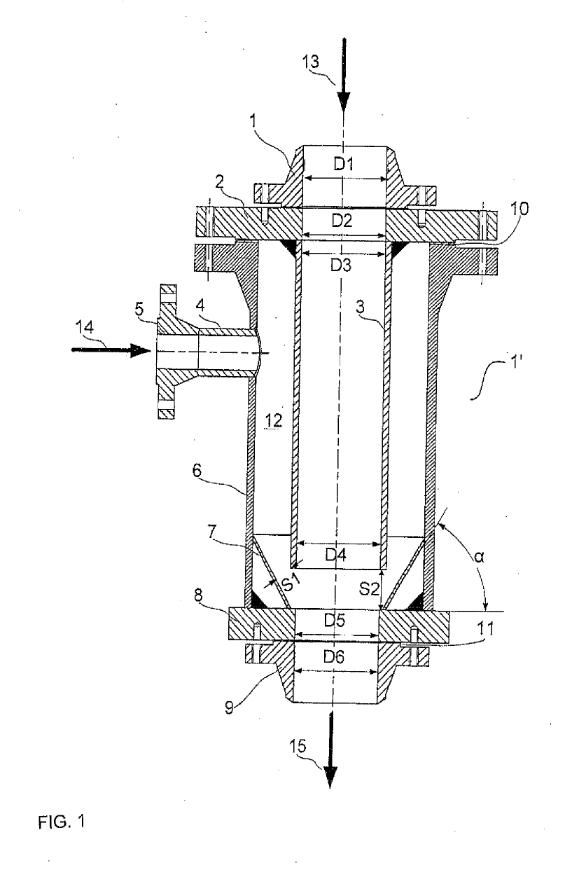

FIG. 1 a device according to the invention, in section,

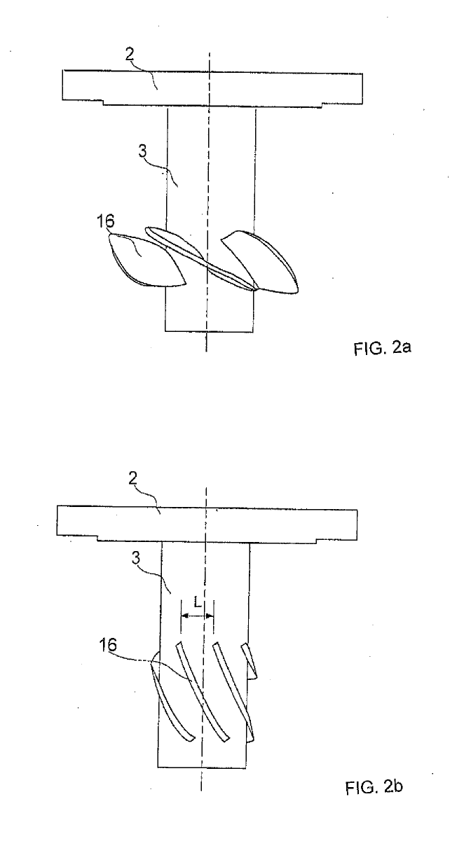

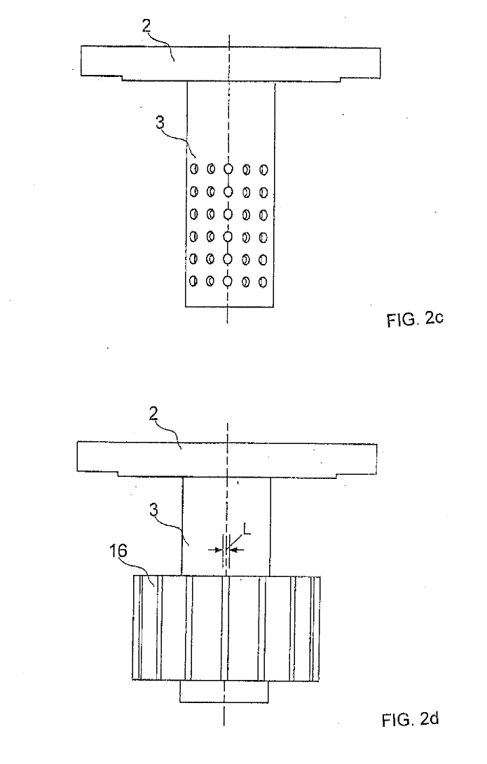

FIG. 2a-2d embodiments of the solid-conveying line in the ring space, with different flow-influencing elements,

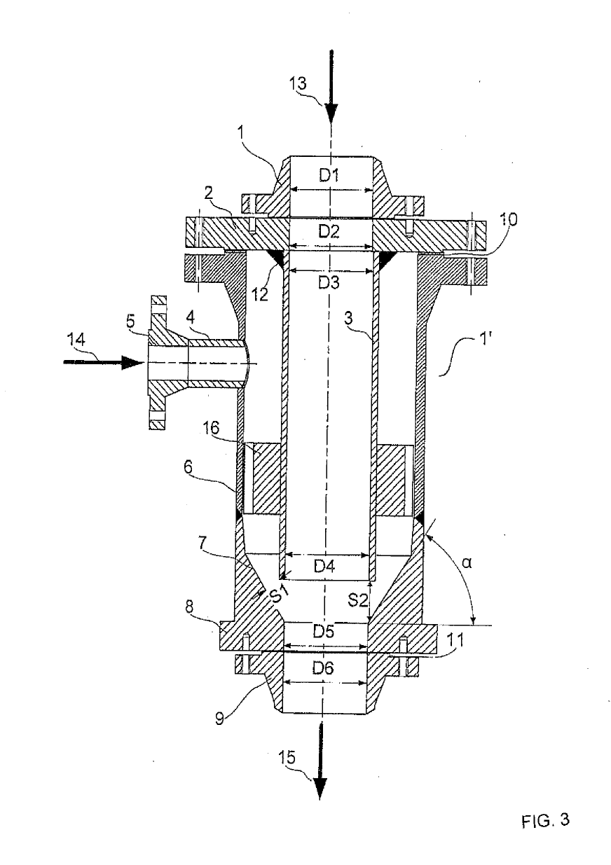

FIG. 3 in the representation according to FIG. 1, a modified exemplary embodiment of the invention, and in

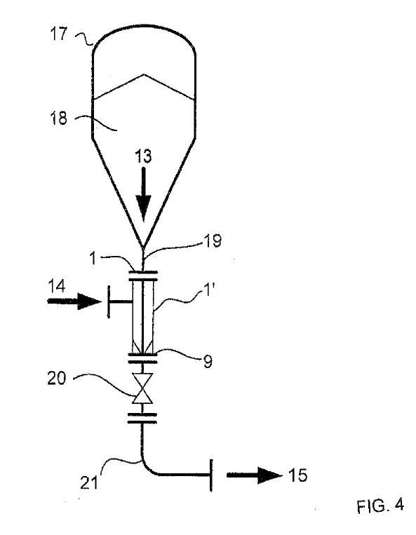

FIG. 4 a block schematic with the device according to the invention indicated, below a container for solid.

The fluidization pipe 1′ shown in FIG. 1 is formed by the housing 6, the inlet flange 2, the outlet flange 8, and the entry 4 for fluidization agent, which entry is connected with a fluidization agent supply system by way of the flange 5. The fluidization pipe is installed into the solid-conveying line by way of the connection flanges 2 and 8. The seal between the flanges 2 and 8 and the flanges 1 and 9 of the incoming or outgoing solid-conveying line, respectively, takes place by way of the sealing rings 10 and 11. The inner guide pipe 3 is firmly connected with the inlet flange 2 of the fluidization pipe. The solid to be conveyed enters into the inner guide pipe 3 by way of the inlet flange 2. Ideally, the diameter of the incoming solids line D1 corresponds to the diameter of the inlet flange D2.

The inlet diameter of the inner guide pipe D3 should preferably be selected to be equal to or slightly greater than the diameter D2 of the inlet flange, in order to avoid disruptions of the solids flow and the occurrence of wear edges at the transition. The fluidization agent is fed into a ring space 12 formed between the inner guide pipe 3 and the housing 6, by way of the entry 4 for fluidization agent.

The fluidization agent distribution chamber is constricted, in the flow direction of the fluidization agent, by means of the cone 7 and the inner guide pipe 3. The narrowest flow cross-section S1 formed in this way should be selected so that the fluidization agent speed at this location preferably corresponds to 1 to 20 times the minimum fluidization speed w_{umf} of the solid. The cone angle α should preferably be selected between 45° and 80°. In the gap S2, the fluidization agent impacts the solid that exits from the inner guide pipe. At the same time, an axial longitudinal expansion of the inner fluidization pipe 3 is compensated by the gap S2. Fluidization takes place in the clear space formed by the inner guide pipe 3 and the outlet flange 8 in the gap S2. The exit from the inner pipe D4 should ideally be selected to be smaller than or equal to the diameter D4 of the subsequent conveying line, in order not to produce an interference edge of the solids flow at the block flange 8. If the diameters D3 and D4 are selected to be different, the inner guide pipe is structured to be conical-narrowing in the flow direction. The fluidized solid leaves the fluidization pipe by way of the solids exit 15.

FIGS. 2a, 2b, 2c, and 2d show different embodiment variants of the inner pipe 3. The inner pipe 3 is firmly connected with the block flange 2, so that this element can be completely replaced, quickly and easily.

FIGS. 2a and 2b show two possibilities, as examples, for producing a vortex flow in the fluidization agent distribution chamber 12 by means of flow bodies 16 that are set on, so that improved mixing of the fluidization agent with the solid is made possible. The fluidization agent flows through the fluidization agent distribution chamber within the flow gaps L between the flow bodies 16. The vortex flow that occurs prevents the formation of solid bridges in the gap S2, for example.

FIG. 2c shows a perforated inner guide pipe 3 with which the solid can already be impacted by fluidization agent as it flows through.

FIG. 2d shows a flow body 16 that is structured as a ring having flow grooves. This flow body has defined flow channels having a flow gap width L. The fluidization agent experiences a pressure loss Δp (flow body) as it flows through these channels, which drop is clearly higher in relation to the pressure loss Δp (solid) of the amount of solid deposited. In this way, uniform fluidization agent distribution is produced in the fluidization agent distribution chamber 12, and deposited solid is removed by the fluidization agent.

FIG. 3 shows the fluidization pipe 1′ according to the invention, whereby cone 7 and outlet flange 8 consist of one component, for example a rotating part. In FIG. 3, the flow body of FIG. 2d is also shown as an example.

FIG. 4 shows the flow profile detail with a typical application case for the fluidization pipe 1′ according to the invention. The fluidization pipe 1′ is attached to a pipe outlet 19 situated on the container 17, by means of a pipe flange 1. The container 17 serves, for example, for interim storage of solid or as a lock for increasing the pressure of the solid stream. When the valve 20 is opened, the solid flows out of the container 17 through the fluidization pipe 1′ and the valve 20, into the solid-conveying line 21. The fluidization pipe can be used in different ways in the schematic, which is shown in simplified manner.

One use is that of introducing gas 14, just before the valve 20 opens to initiate solid transport, in such an amount that local fluidization begins above the valve 20. In this manner, the switching process is simplified; at the same time, the solid is loosened by means of the fluidization, so that any solid bridges that might have formed are eliminated.

Another use or another operating state is that the gas 14 fed in is adjusted, during the solid-conveying process, to the amount that is necessary for adjusting the density required for reliable dense-stream conveying, for example. Once the solid-conveying process has been completed, in other words the container is empty, the line can be flushed by means of an increased amount of gas 14. Because large amounts of gas are needed for short periods of time for the first fluidization, for example, but also for the final flushing, the use of sintered metals is problematic here. Here, the device according to the invention, with the gas feed gap S1, offers process technology advantages in connection with longer expected useful lifetimes, as compared with the solution using sintered metals.

### REFERENCE SYMBOL LIST

1′ fluidization pipe
1 pipeline flange
2 inlet flange of fluidization pipe
3 inner guide pipe
4 entry for fluidization agent
5 flange
6 housing
7 cone
8 outlet flange of fluidization pipe
9 pipeline flange
10/11 sealing ring
12 ring space
13 entry for solids
14 feed for fluidization agent
15 exit for solids
16 flow body
17 container
18 bulk solids
19 pipe outlet
20 valve
21 solid-conveying line
D1 diameter of pipeline
D2 diameter of inlet for solids
D3 diameter of inlet of inner guide pipe
D4 diameter of outlet of inner guide pipe
D5 diameter of fluidization pipe outlet
D6 diameter of pipeline
S1 narrowest cross-section of fluidization ring
S2 expansion gap
α cone angle
L flow gap

1-6. (canceled)

7. Device for feeding a fluid, such as a gas or a liquid, into a solid-conveying line, wherein the fluid is first passed into a ring space that surrounds the solid-conveying line, and from there into the solid-conveying line, wherein the solid-conveying line (inner guide pipe (3)), is shorter, in the ring space (12) for forming a ring gap, than the length of the ring space, wherein installations for producing a vortex flow of the fluid that is introduced are provided in the ring space (12), wherein the region of the inner guide pipe (3) is configured to be at least partially perforated in the ring space (12).

8. Device according to claim 7, wherein flow-guiding installations (16) are provided in the ring space (12).

9. Device according to claim 7, wherein the ring space (12) is equipped with a funnel-shaped wall region in the region of the ring gap to the inner guide pipe (3).

10. Device according to claim 7, wherein the device elements are attached to one another by way of flange connections (2, 8).

11. Device according to claim 7, wherein the feed line to the ring space for the fluid is positioned in the upper region, in the direction of gravity, of the ring space, if the solid-conveying line is not positioned in the direction of gravity.
